(19) United States
(12) Patent Application Publication
(10) Pub. No.: US 2019/0167515 A1
(43) Pub. Date: Jun. 6, 2019

(54) ONE-WAY SELF-LOCKING DEVICE FOR MASSAGER

(71) Applicant: XIAMEN COMFIER TECHNOLOGY CO., LTD., Xiamen City, Fujian (CN)

(72) Inventor: Jianqing Li, Xiamen City (CN)

(73) Assignee: XIAMEN COMFIER TECHNOLOGY CO., LTD., Xiamen City, Fujian (CN)

(21) Appl. No.: 16/313,888

(22) PCT Filed: May 15, 2017
(86) PCT No.: PCT/CN2017/084309

§ 371 Date: Dec. 28, 2018

(51) Int. Cl. A61H 23/00

(52) U.S. Cl. CPC A61H 23/004; A61H 2201/149; A61H 23/006

(57) ABSTRACT

A one-way self-locking device for a massager includes a transmission shaft, a shaft sleeve, a torsional spring, and a big belt wheel. The big belt wheel is rotatably sleeved on the transmission shaft, and the big belt wheel is driven by a power mechanism to drive the transmission shaft to circumferentially rotate. The shaft sleeve is fixedly mounted on the transmission shaft. The torsional spring is sleeved on the shaft sleeve. A first connecting portion of the torsional spring is in interference fit with the shaft sleeve, a main body portion of the torsional spring is sleeved on the shaft sleeve and is in clearance fit with the shaft sleeve, and a second connecting portion of the torsional spring is fixedly connected to the big belt wheel to achieve one-way self-locking.

### BACKGROUND OF THE INVENTION

### 1. Field of the Invention

The present invention relates to a massager, and more particularly to a one-way self-locking device for a massager.

### 2. Description of the Prior Art

In the prior art, the structure of the massager is various, and the massager has various functions. Chinese Utility Model Application No. 201620154219.1 discloses a multifunctional massager, comprising a core body and a swing arm disposed on the core body. A motor is arranged in the core body. The motor drives a transmission assembly. The transmission assembly drives the swing arm to swing right and left for tapping massage. The transmission assembly consists of a small pulley, a belt, a big pulley, a transmission shaft, a deflection seat, a bearing and a bearing seat. The small pulley is disposed on the shaft of the motor. The power is transmitted to the big pulley through the belt. The big pulley is connected with the transmission shaft. The deflection seat includes two deflection seats that are spaced and mounted on the transmission shaft. The deflection seat is connected with the bearing and the bearing seat. Two ends of the swing arm are connected to the bearing seat. The big pulley drives the transmission shaft. The transmission shaft drives the deflection seat, so that the deflection seat drives the swing arm to sway up and down.

In order to realize the one-way self-locking function of the transmission shaft, as shown in FIG. 1, a one-way bearing 20 is mounted on a transmission shaft 10. A big pulley 30 is fixedly mounted on the transmission shaft 10. A motor drives the big pulley 30 to rotate the transmission shaft 10 through a belt. The one-way bearing 20 realizes the one-way self-locking function of the transmission shaft 10.

However, the one-way self-locking structure has a drawback in that the one-way bearing 20 is relatively noisy during the movement, and the one-way bearing 20 has a higher cost of use.

### SUMMARY OF THE INVENTION

The primary object of the present invention is to provide a one-way self-locking device for a massager. One-way self-locking is achieved by means of decrease and increase of the internal diameter of a torsional spring. The structure is simple and costs are low.

In order to achieve the above object, the present invention adopts the following technical solutions:

A one-way self-locking device for a massager comprises a transmission shaft, a shaft sleeve, a torsional spring, and a big belt wheel. The transmission shaft is rotatably mounted in a housing of a massager. The big belt wheel is rotatably sleeved on the transmission shaft. The big belt wheel is driven by a power mechanism to drive the transmission shaft to rotate circumferentially. The transmission shaft drives a massage component to work through a deflection component. The shaft sleeve is fixedly mounted on the transmission shaft. The torsional spring is sleeved on the shaft sleeve. The torsional spring consists of a main body portion and a first connecting portion and a second connecting portion that are disposed on two sides of the main body portion. The first connecting portion of the torsional spring is in a lapped connection with the shaft sleeve and is in interference fit with the shaft sleeve. The main body portion of the torsional spring is sleeved on the shaft sleeve and is in clearance fit with the shaft sleeve. The second connecting portion of the torsional spring is fixedly connected to the big belt wheel.

Preferably, the material of the torsion spring is a piano wire.

Preferably, the shaft sleeve is provided with a stop wall, and the first connecting portion of the torsion spring is axially limited to one side of the stop wall.

Preferably, the first connecting portion of the torsion spring has a U shape.

Preferably, the second connecting portion of the torsion spring is a hook portion. The hook portion is engaged on a protruding block of the big belt wheel. A screw is locked on the big belt wheel to limit and fix the second connecting portion of the torsion spring.

With the above solution, the first connecting portion of the torsion spring of the present invention is lapped on the shaft sleeve and is in interference fit with the shaft sleeve. The main body portion of the torsion spring is sleeved on the shaft sleeve and is in clearance with the shaft sleeve. The second connecting portion of the torsion spring is fixedly connected to the big belt wheel.

When the motor drives the big belt wheel to move counterclockwise, the big belt wheel drives the torsion spring to be tightened, and the inner diameter of the main body portion of the torsion spring is reduced, so that the inner circumferential surface of the torsion spring is in interference fit with the outer circumferential surface of the shaft sleeve. The friction between the torsion spring and the shaft sleeve is increased, thereby forming a self-locking between the two. When the motor drives the big belt wheel to move clockwise, the big belt wheel drives the torsion spring to loosen, and the inner diameter of the torsion spring becomes larger. The fit between the inner circumferential surface of the torsion spring and the outer circumferential surface of the shaft sleeve is converted to a clearance fit form an interference fit, thereby releasing the self-locking between the two.

One-way self-locking is achieved by means of decrease and increase of the internal diameter of the torsional spring of the present invention. The present invention has a simple structure, reduces accuracy requirements, is safe and reliable, and has low cost. In a natural state, the first connecting portion of the torsion spring is in a lapped connection with the shaft sleeve and is in interference fit with the shaft sleeve, and the main body portion of the torsional spring is sleeved on the shaft sleeve and is in clearance fit with the shaft sleeve, thereby minimize noise during operation.

### BRIEF DESCRIPTION OF THE DRAWINGS

FIG. 1 is a schematic view of the structure of the prior art;

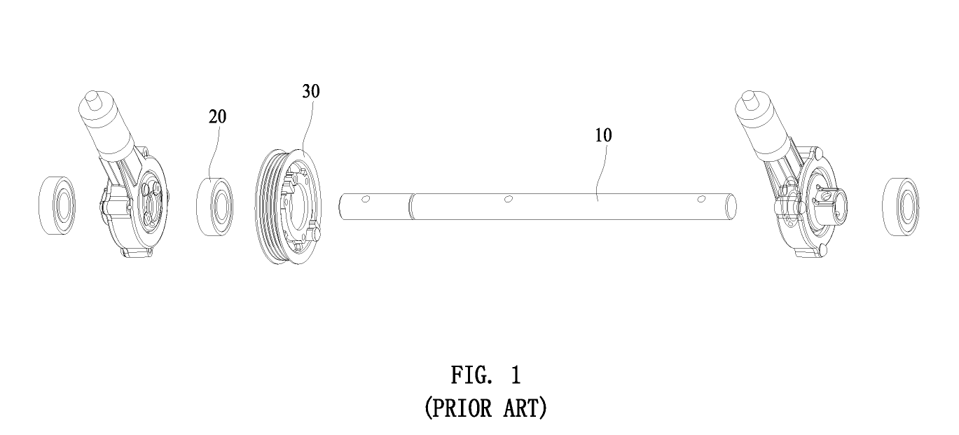

FIG. 2 is a perspective view of the present invention;

FIG. 3 is another perspective view of the present invention;

FIG. 4 is an exploded view of the present invention;

FIG. 5 is a schematic view of the present invention in cooperation with the rocker arm;

FIG. 6 is a schematic view of the present invention in cooperation with the motor;

FIG. 7 is a schematic view of the massager of the present invention; and

FIG. 8 is a partially exploded view of the massager of the present invention.

### DETAILED DESCRIPTION OF THE PREFERRED EMBODIMENTS

Embodiments of the present invention will now be described, by way of example only, with reference to the accompanying drawings.

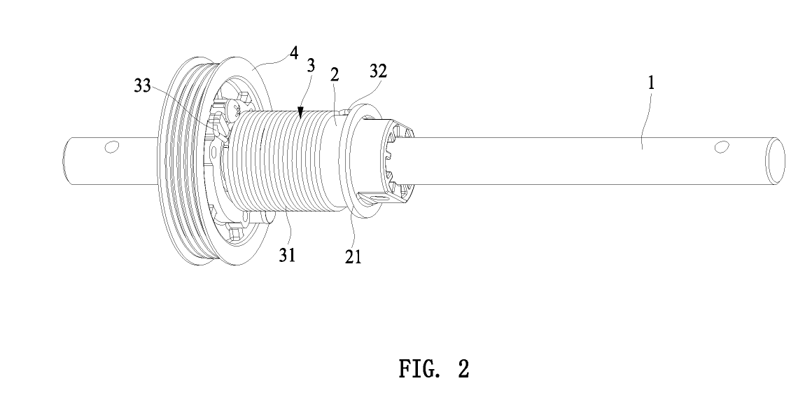

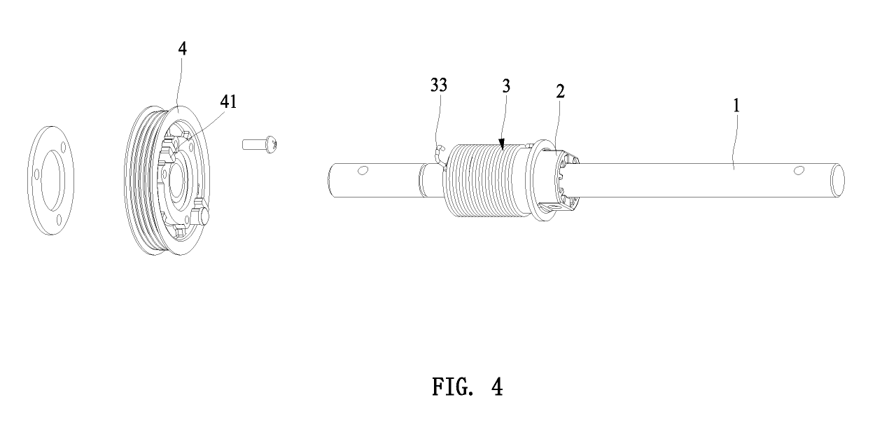

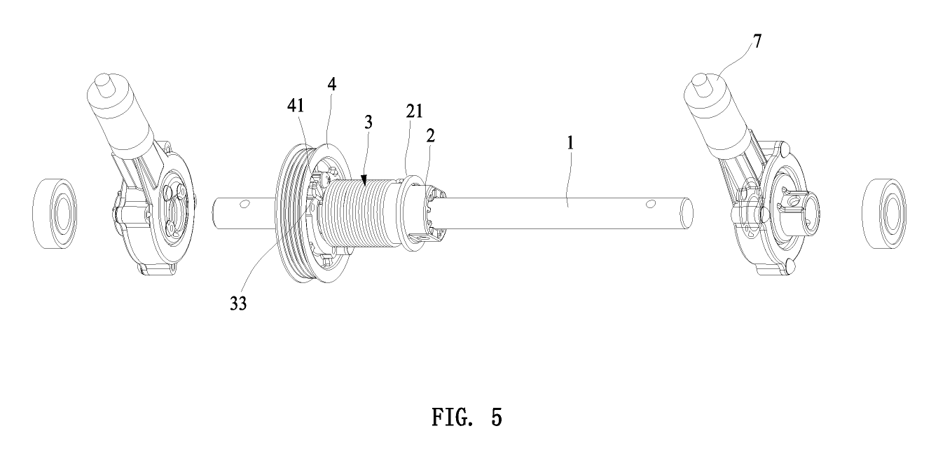

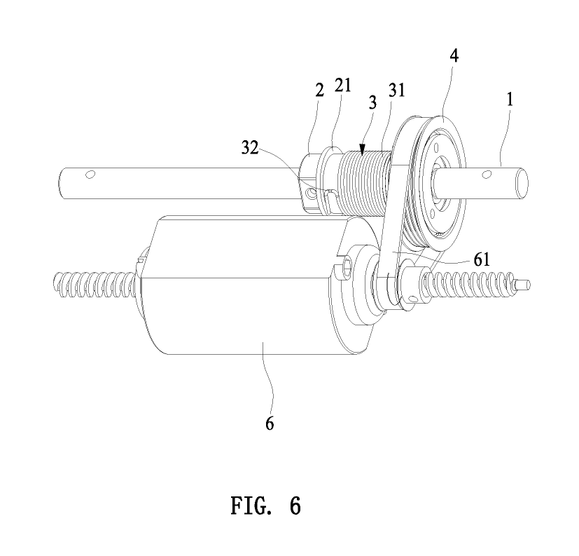

Referring to FIG. 2 through FIG. 8, the present invention discloses a one-way self-locking device for a massager, comprising a transmission shaft 1, a shaft sleeve 2, a torsional spring 3, and a big belt wheel 4.

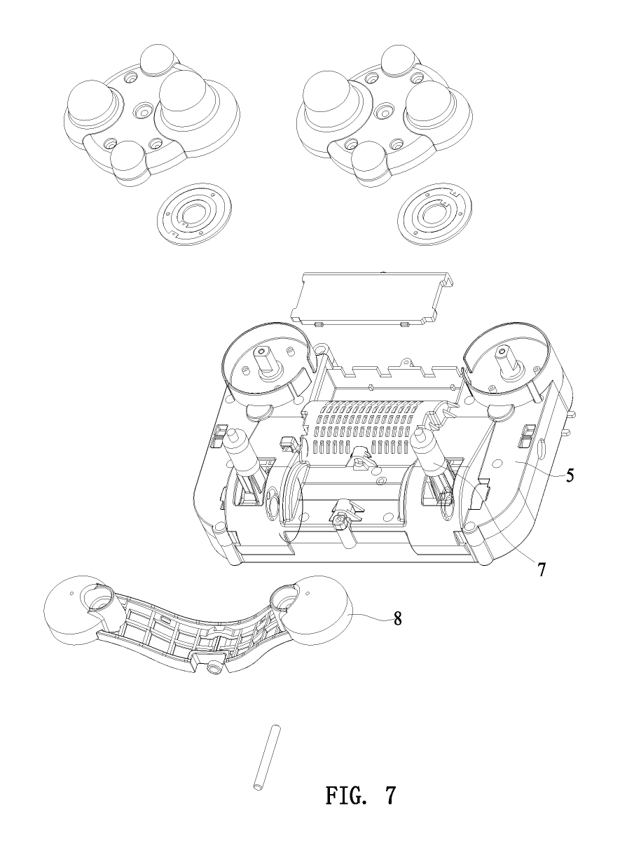

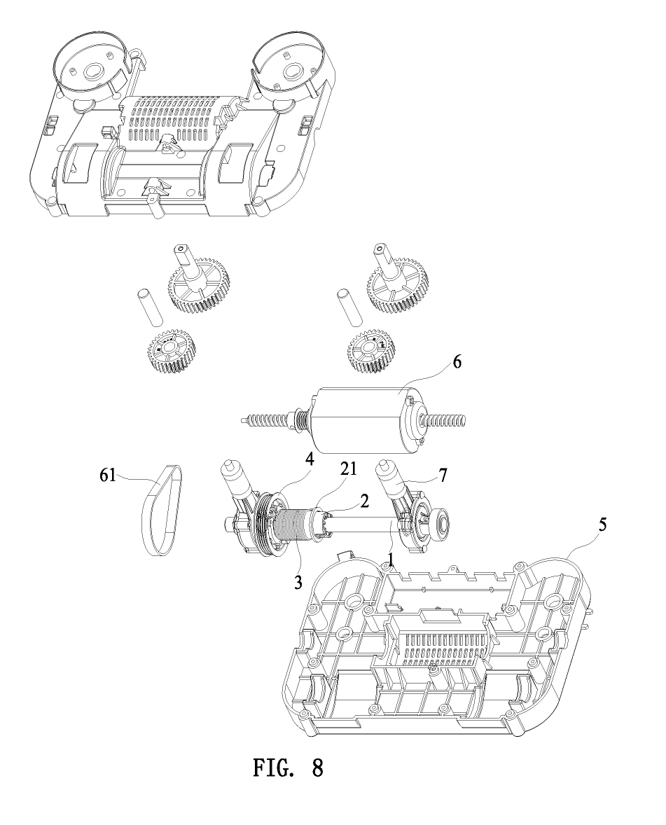

The transmission shaft 1 is rotatably mounted in a housing 5 of the massager. As shown in FIG. 7 and FIG. 8, generally, both ends of the transmission shaft 1 are rotatably mounted in the housing 5 through bearings.

The big belt wheel 4 is rotatably sleeved on the transmission shaft 1. The big belt wheel 4 is driven by a power mechanism 6 to drive the transmission shaft 1 to circumferentially rotate. The transmission shaft 1 drives a massage component 8 to work through a deflection component 7. Specifically, the deflection component 7 is fixedly mounted on the transmission shaft 1. The deflection component 7 moves with the transmission shaft 1, and the deflection component 7 drives the massage component 8 to move. As shown in FIG. 7 and FIG. 8, the power mechanism 6 is a motor. The motor drives the big belt wheel 4 to rotate the transmission shaft 1 circumferentially via a belt 61. The massage component 8 may be a rocker arm. The transmission shaft 1 drives the rocker arm to actuate through the deflecting component 7. The motor also drives a kneading massage head.

The shaft sleeve 2 is fixedly mounted on the transmission shaft 1. It is usually fixedly mounted on the transmission shaft 1 by means of a pin hole and a pin shaft. The torsional spring 3 is sleeved on the shaft sleeve 2. The material of the torsion spring 3 is preferably a piano wire.

The torsional spring 3 consists of a main body portion 31 and a first connecting portion 32 and a second connecting portion 33 that are disposed on two sides of the main body portion 31. The first connecting portion 32 of the torsional spring 3 is in a lapped connection with the shaft sleeve 2 and is in interference fit with the shaft sleeve 2. The main body portion 31 of the torsional spring 3 is sleeved on the shaft sleeve 2 and is in clearance fit with the shaft sleeve 2. The second connecting portion 33 of the torsional spring 3 is fixedly connected to the big belt wheel 4.

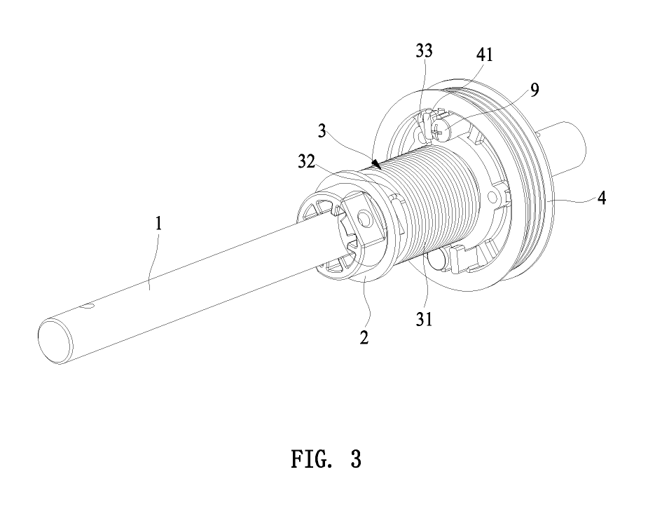

The first connecting portion 32 of the torsion spring 3 has a U shape. The second connecting portion 33 of the torsion spring 3 is a hook portion. The hook portion is engaged on a protruding block 41 of the big belt wheel 4. As shown in FIG. 3, a screw 9 is locked on the big belt wheel 4 to limit and fix the second connecting portion 33 of the torsion spring 3.

As shown in FIG. 2, the shaft sleeve 2 is provided with a stop wall 21. The first connecting portion 32 of the torsion spring 3 is axially limited to one side of the stop wall 21.

When the motor drives the big belt wheel 4 to move counterclockwise, the big belt wheel 4 drives the torsion spring 3 to be tightened, and the inner diameter of the main body portion 31 of the torsion spring 3 is reduced, so that the inner circumferential surface of the torsion spring 3 is in interference fit with the outer circumferential surface of the shaft sleeve 2. The friction between the torsion spring 3 and the shaft sleeve 2 is increased, thereby forming a self-locking between the two. When the motor drives the big belt wheel 4 to move clockwise, the big belt wheel 4 drives the torsion spring 3 to loosen, and the inner diameter of the torsion spring 3 becomes larger. The fit between the inner circumferential surface of the torsion spring 3 and the outer circumferential surface of the shaft sleeve 2 is converted to a clearance fit form an interference fit, thereby releasing the self-locking between the two.

One-way self-locking is achieved by means of decrease and increase of the internal diameter of the torsional spring 3 of the present invention. The present invention has a simple structure, reduces accuracy requirements, is safe and reliable, and has low cost. In a natural state, the first connecting portion 32 of the torsion spring 3 is in a lapped connection with the shaft sleeve 2 and is in interference fit with the shaft sleeve 2, and the main body portion 31 of the torsional spring 3 is sleeved on the shaft sleeve 2 and is in clearance fit with the shaft sleeve 2, thereby minimize noise during operation.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A one-way self-locking device for a massager, comprising a transmission shaft, a shaft sleeve, a torsional spring, and a big belt wheel; the transmission shaft being rotatably mounted in a housing of a massager, the big belt wheel being rotatably sleeved on the transmission shaft, the big belt wheel being driven by a power mechanism to drive the transmission shaft to rotate circumferentially, the transmission shaft driving a massage component to work through a deflection component; the shaft sleeve being fixedly mounted on the transmission shaft, the torsional spring being sleeved on the shaft sleeve, the torsional spring consisting of a main body portion and a first connecting portion and a second connecting portion that are disposed on two sides of the main body portion, the first connecting portion of the torsional spring being in a lapped connection with the shaft sleeve and being in interference fit with the shaft sleeve, the main body portion of the torsional spring being sleeved on the shaft sleeve and being in clearance fit with the shaft sleeve, the second connecting portion of the torsional spring being fixedly connected to the big belt wheel.

2. The one-way self-locking device as claimed in claim 1, wherein the material of the torsion spring is a piano wire.

3. The one-way self-locking device as claimed in claim 1, wherein the shaft sleeve is provided with a stop wall, and the first connecting portion of the torsion spring is axially limited to one side of the stop wall.

4. The one-way self-locking device as claimed in claim 1, wherein the first connecting portion of the torsion spring has a U shape.

5. The one-way self-locking device as claimed in claim 1, wherein the second connecting portion of the torsion spring is a hook portion, the hook portion is engaged on a protruding block of the big belt wheel, a screw is locked on the big belt wheel to limit and fix the second connecting portion of the torsion spring.
